(19) United States
(12) Patent Application Publication
(10) Pub. No.: US 2012/0019335 A1
(43) Pub. Date: Jan. 26, 2012

(54) SELF COMPENSATED DIRECTIONAL COUPLER

(76) Inventors: Dinhphuoc V. Hoang, Stanton, CA (US); Guohao Zhang, Irvine, CA (US); Anil Agarwal, Ladera Ranch, CA (US)

(21) Appl. No.: 12/887,789

(22) Filed: Sep. 22, 2010

Related U.S. Application Data
(60) Provisional application No. 61/365,848, filed on Jul. 20, 2010.

(51) Int. Cl. H01P 5/18

(52) U.S. Cl. 333/116

(57) ABSTRACT

A self-compensated strip-coupled directional coupler. In one example, the self-compensated directional coupler includes a main arm formed in a single first layer of a multi-layer substrate, and a coupled arm formed in a single second layer of the multi-layer substrate. One of the coupled arm and the main arm includes a zigzag structure to compensate for misalignment between the first and second layers that can occur during manufacturing.

### CROSS REFERENCE TO RELATED APPLICATIONS

This application claims the benefit under 35 U.S.C. §119(e) of U.S. Provisional Application No. 61/365,848 entitled “SELF COMPENSATED DIRECTIONAL COUPLER” filed on Jul. 20, 2010, which is herein incorporated by reference in its entirety.

### BACKGROUND

1. Field of Invention

The present invention relates generally to the field of electronic transmission line devices and, more particularly, to directional couplers.

2. Discussion of Related Art

Directional couplers are passive devices used in many radio frequency (RF) applications, including for example, power amplifier modules. Directional couplers couple part of the transmission power in a transmission line by a known amount out through another port, in the case of microstrip or stripline couplers by using two transmission lines set close enough together such that energy passing through one is coupled to the other. Microstrip and stripline couplers are widely implemented in power amplifier modules, particularly those used in telecommunications applications, using multi-layer laminate printed circuit boards (PCBs) due to ease of fabrication and low cost. Conventionally, these couplers are realized by placing the main RF arm and the coupled arm on two adjacent PCB layers and maintaining exact overlap of the two structures to provide the RF coupling. One limitation of these laminate-based couplers is that the directivity and coupling factor changes dramatically with manufacturing process variations such as, for example, layer-to-layer misalignment between the main arm and the coupled arm formed on separate layers, and etching tolerances of the transmission lines. This results in poor control of the RF output power in systems using these couplers.

There have been several proposals to address such variations in coupler performance and to improve the directivity of laminate-based couplers. For example, supplementary slot lines that extend the length of the coupler have been used to compensate for different phase velocities of the even and odd modes of the coupler, as discussed in “Microstrip-Slot Coupler Design-Part I: S-parameters of Uncompensated and Compensated Couplers,” Reinmut K. Hoffman et al., IEEE Transactions on Microwave Theory and Techniques, Vol. MTT-30, No. 8, August 1982. Various techniques for improving directional coupler performance involve adding extra components to the coupler, such as inductors added at the ends of the main arm and coupled arm, and optionally shunt capacitors. Another technique involves placing a floating metal plate on parallel-coupled microstrip lines to enhance the coupling between the lines, as discussed in “Closed-Form Equations of Conventional Microstrip Couplers Applied to Design Couplers and Filters Constructed With Floating-Plate Overlay,” Kuo-Sheng Chin et al., IEEE Transactions on Microwave Theory and Techniques, Vol. 56, No. 5, May 2008. Another technique for enhancing the directivity of microstrip directional couplers includes the use of feedback elements between the collinear ports of the parallel-line couplers. The use of a feed-forward compensation circuit connected to the coupled ports of a directional coupler to increase the directivity and/or isolation of the coupler has also been proposed.

### SUMMARY OF INVENTION

Aspects and embodiments are directed to a self-compensated strip coupled coupler having a structure that automatically compensates for misalignment, caused by manufacturing tolerances, between layers of a multi-layer substrate in which the coupler is implemented.

According to one embodiment, a directional coupler comprises a main arm formed in a single first layer of a multi-layer substrate, and a coupled arm formed in a single second layer of the multi-layer substrate, wherein one of the coupled arm and the main arm includes a zigzag structure having a first portion and a second portion connected together by a joining portion.

In one example, the first layer is a first metal layer of the multi-layer substrate, the second layer is a second metal layer of the multi-layer substrate, the first and second metal layers are separated from one another by a dielectric layer, and the second metal layer is closer to the ground plane than is the first metal layer. In another example, the directional coupler further comprises an input port coupled to a proximal end of the main arm, a transmitted port coupled to a distal end of the main arm, a coupled port coupled to a proximal end of the coupled arm, and an isolated port coupled to a distal end of the coupled arm. In one example, the multi-layer substrate is a multi-layer printed circuit board. According to one example, the joining portion is substantially perpendicular to the first and second portions in a plane of the second layer. In another example, the zigzag structure is approximately centered about the main arm. 9. In another example, a width of the coupled arm is tapered on either side of the zigzag such that the width of the coupled arm increases with distance away from the zigzag.

According to another embodiment, a method of designing a self-compensated directional coupler comprises laying out two parallel transmission lines, the two parallel transmission lines including a main line and a coupled line, creating a zigzag in one of the main line and the coupled line, the zigzag being approximately symmetrical about the other of the main line and the coupled line, and determining a first width of the main line, a second width of the coupled line, and a spacing between the main line and the coupled line based on predetermined desired performance characteristics of the self-compensated directional coupler.

The method may further comprise optimizing at least one of the performance characteristics of the self-compensated directional coupler by adjusting parameters of the two transmission lines. In one example, adjusting the parameters of the two transmission lines includes adjusting at least one of the first width, the second width, and the spacing. Determining the first width, the second width and the spacing may include, for example, determining the first width, the second width and the spacing based at least in part on a desired coupling factor of the self-compensated directional coupler. In one example, creating the zigzag includes creating the zigzag in the coupled line, the zigzag being approximately symmetrical about the main line. In another example, creating the zigzag includes creating the zigzag in the main line, the zigzag being approximately symmetrical about the coupled line.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIG. 1 is a block diagram of one example of a system including a directional coupler;

FIG. 2 is a diagram of one example of a conventional strip coupled directional coupler implemented on a multi-layer printed circuit board;

FIG. 3A is a plan view diagram of one example of a self-compensated strip coupled coupler implemented on a multi-layer printed circuit board, according to aspects of the present invention;

FIG. 3B is a cross-sectional diagram of the a self-compensated strip coupled coupler of FIG. 3A;

FIG. 3C is a plan view diagram of another example of a self-compensated strip coupled coupler implemented on a multi-layer printed circuit board, according to aspects of the present invention;

FIG. 3D is a plan view diagram of another example of a self-compensated strip coupled coupler implemented on a multi-layer printed circuit board, according to aspects of the present invention;

FIG. 3E is a plan view diagram of another example of a self-compensated strip coupled coupler implemented on a multi-layer printed circuit board, according to aspects of the present invention;

FIG. 4 is a flow diagram illustrating one example of a method of designing a self-compensated strip coupled coupler according to aspects of the present invention;

FIG. 5A is a diagram of a printed circuit board layout of an example of strip coupled coupler corresponding to step 400 in the method of FIG. 4 according to aspects of the invention;

FIG. 5B is a diagram of a printed circuit board layout of an example of a self-compensated strip coupled coupler corresponding to step 410 of the method if FIG. 4 according to aspects of the invention;

FIG. 5C is a diagram of another printed circuit board layout of the example of the self-compensated strip coupled coupler, according to aspects of the invention;

FIG. 5D is a diagram of another printed circuit board layout of the example of the self-compensated strip coupled coupler, according to aspects of the invention;

FIG. 5E is a diagram of another printed circuit board layout of the example of the self-compensated strip coupled coupler, according to aspects of the invention;

FIG. 6 is a schematic block diagram of one example of a multi-layer substrate in which a coupler according to aspects of the invention may be implemented;

FIG. 7A is a diagram of a nominal circuit board layout of a simulated conventional strip coupled coupler;

FIG. 7B is a diagram of a circuit board layout for the conventional coupler of FIG. 7A with misalignment in the y-direction;

FIG. 8A is a diagram of a nominal circuit board layout for a simulated self-compensated directional coupler according to aspects of the invention;

FIG. 8B is a diagram of a circuit board layout for the simulated self-compensated directional coupler of FIG. 8A with misalignment in the y-direction;

FIG. 9A is a graph of the simulated coupling factor (in dB) of the conventional couplers of FIGS. 7A and 7B as a function of frequency (in gigahertz (GHz));

FIG. 9B is a graph of the simulated coupling factor (in dB) of the example self-compensated couplers of FIGS. 8A and 8B as a function of frequency (in GHz);

FIG. 10A is a graph of the simulated isolation (in dB) of the conventional couplers of FIGS. 7A and 7B as a function of frequency (in GHz);

FIG. 10B is a graph of the simulated isolation (in dB) of the example self-compensated couplers of FIGS. 8A and 8B as a function of frequency (in GHz);

FIG. 11A is a graph of the simulated directivity (in dB) of the conventional couplers of FIGS. 7A and 7B as a function of frequency (in GHz);

FIG. 11B is a graph of the simulated directivity (in dB) of the example self-compensated couplers of FIGS. 8A and 8B as a function of frequency (in GHz); and

FIG. 12 is a graph of simulated and measured isolation and coupling factor (in dB) for the example self-compensated coupler of FIG. 8A as a function of frequency (in GHz).

### DETAILED DESCRIPTION

As discussed above, manufacturing process variations such as the layer to layer misalignment between the main and coupled arms described on separate layers and the etching tolerance of such transmission lines, can dramatically affect the directivity and coupling factor of laminate-PCB (printed circuit board) based coupled-line couplers. Conventional solutions, such as those discussed above, suffer from several disadvantages. For example, the use of extended slot lines or floating-plate metal overlays has the disadvantage that the floating metal added on top of the coupler acts as an unwanted antenna, which may negatively impact coupler performance and severely interfere with output matching, therefore degrading performance of a power amplifier connected to the coupler output. In addition, the extra slot lines or floating metal plates require extra space in the PCB module in which the coupler is implemented. Similarly, conventional solutions that involve the use of additional capacitors and/or inductors also require additional space in the module. The feedback technique discussed above also have disadvantages in design, including the need for two PCB printed inductors in the package/module to compensate for coupler performance. These inductors use additional space, and are difficult to tune, which may negatively impact performance of the coupler and/or components (such as a power amplifier) connected to the coupler output as well.

Aspects and embodiments are directed to a coupled line structure that overcomes the layer-to-layer alignment issues in multilayer PCB manufacturing discussed above, without requiring additional components. Embodiments of the coupler are designed with the coupled line divided into two equal lengths (zig-zag, as discussed further below. This structure provides a coupler with very stable coupling factor and directivity even in circumstances of PCB process variations or misalignment in X-Y direction, as also discussed further below. Since the coupler requires no additional components, interference with an output-coupled power amplifier (or other components) may be minimized, and degradation of power amplifier performance avoided. Examples of the coupled line structures have been designed and simulated, as discussed further below. Simulation data for coupling factor and directivity indicate a vast improvement over conventional laminate-based coupler designs. In addition, the simulation data validates that embodiments of the coupler are independent of alignment variations due to the inherent misalignment present in manufacturing processes of multilayer laminate PCBs, as discussed in more detail below.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

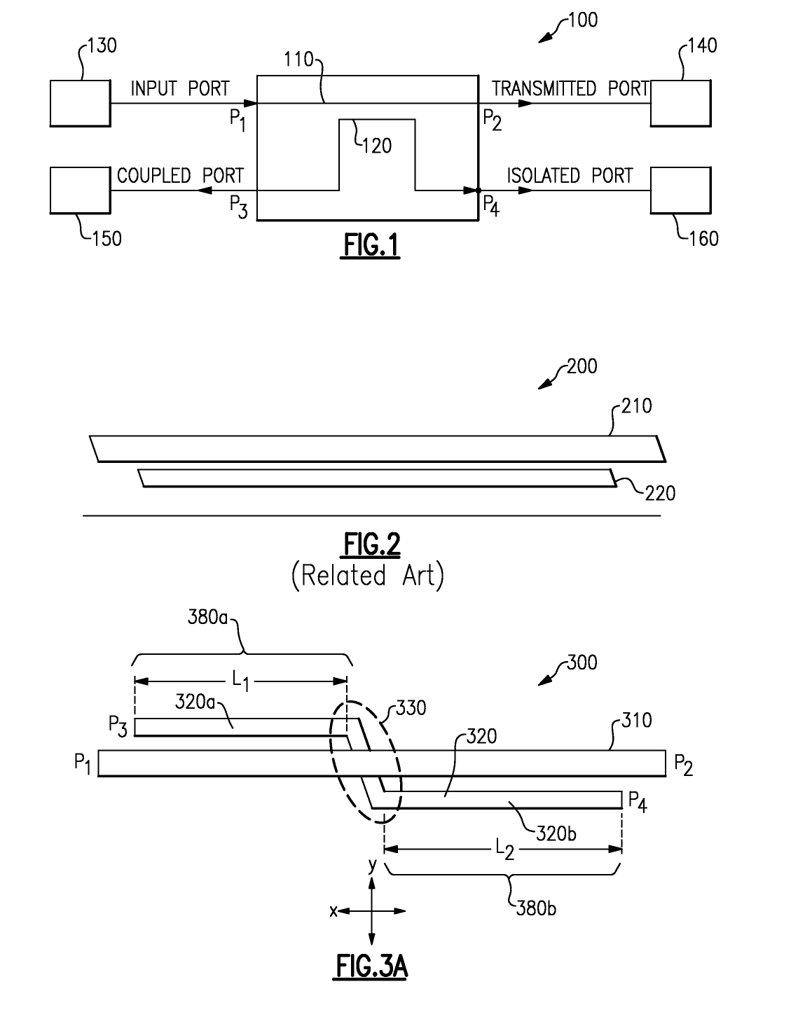

As illustrated in FIG. 1, a directional coupler 100 has four ports, namely an input port P1, a transmitted port P2, a coupled port P3, and an isolated port P4. The term “main arm” refers to the transmission line section 110 of the coupler between ports P1 and P2. The term “coupled arm” refers to the transmission line section 120. An input radio frequency (RF) signal is supplied at port P1 of the coupler 100 from an RF generator 130. The majority of this input signal is passed, via the main arm 110 of the coupler 100 to a signal recipient 140 coupled to port P2 of the coupler, and a portion of the signal, for example 1% of the signal for a 20 dB coupler, is supplied via the coupled arm 120 to a detector 150 coupled to port P3. The devices acting as the RF generator 130, signal recipient 140 and detector 150, and configuration thereof, may depend on the system in which the coupler 100 is used. For example, the RF generator 130 may be a power amplifier, a switch, a transceiver, or any other device from which it may be desirable to take a sample (at the coupled port P3) of its output signal. The signal recipient 140 may include, for example, a switch, another power amplifier, an antenna, a filter, and the like. By providing a sample of the RF input signal at the coupled port P3, the coupler 100 provides an indirect way of measuring the RF input signal. The detector 150 may include, for example, a sensor or feedback controller that uses the signal detected at the coupled port P3 to provide information to the system and/or to adjust/control the RF input signal. Often the isolated port P4 is terminated with an internal or external matched load 160, for example, a 50 Ohm or 75 Ohm load. It is to be appreciated that since the directional coupler is a linear device, the notations on FIG. 1 are arbitrary. Any port can be the input port, which will result in the directly connected port being the transmitted port, the adjacent port being the coupled port, and the diagonal port being the isolated port (for stripline and microstrip couplers).

For accurate signal analysis, it may be necessary to provide a certain stability and/or quality of the signal at the coupled port P3. Generally, only a small percentage (e.g., 1%) of the RF input signal is provided at the coupled port P3 because reducing power at the transmitted port P2 reduces system efficiency. As a result, because the signal amplitude at the coupled port P3 may generally be low, variations in the coupling factor, which affect the signal power at the coupled port P3, may significantly affect the coupled signal and therefore the quality of the measurements that can be made by the detector 150. Furthermore, maintaining a stable power level at the coupled port P3 may be important as it may be undesirable to have to frequently recalibrate the detector 150 due to fluctuations in the signal level at the coupled port P3. In conventional strip-coupled couplers it is difficult to provide a stable coupling factor due to manufacturing inaccuracies that arise from process limitations in the manufacturing process. For example, referring to FIG. 2, there is illustrated a diagram of a conventional strip coupled directional coupler 200 implemented on a multi-layer laminate PCB. The main RF arm 210 and the coupled arm 220 on formed on two adjacent PCB layers (not shown), and RF coupling between the two arms is dependent on the overlap of the two arms, and therefore on the alignment of the two PCB layers. By contrast, aspects and embodiments are directed to a self-compensated coupler having a structure that automatically compensates for small misalignment between PCB layers, as may typically occur during manufacturing, and performance which is therefore independent of such misalignments.

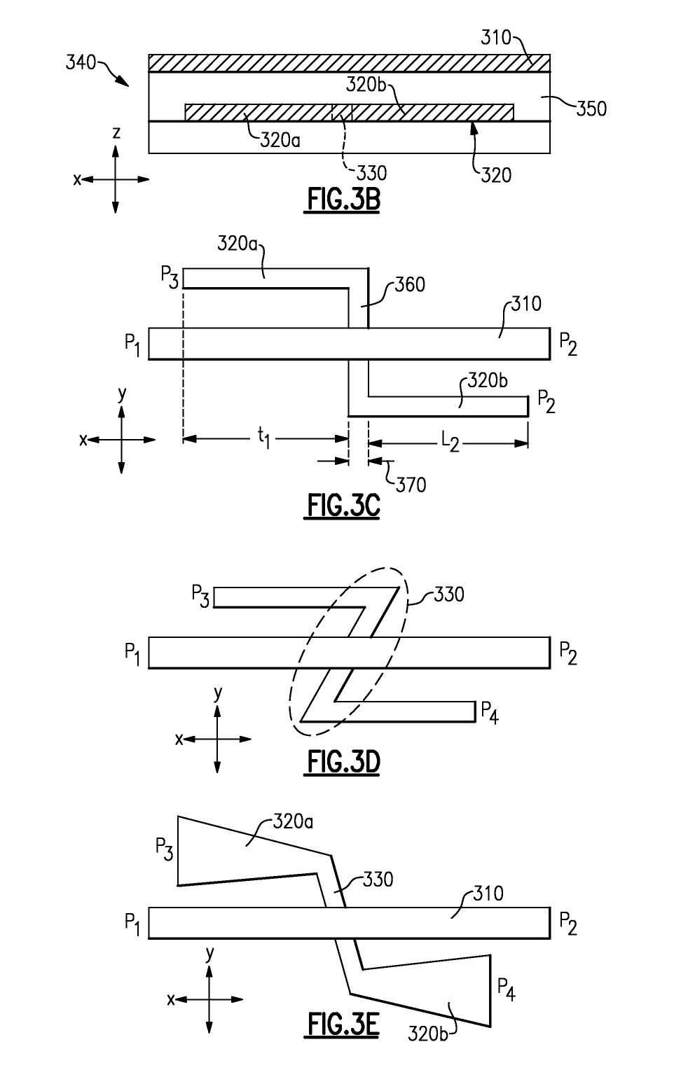

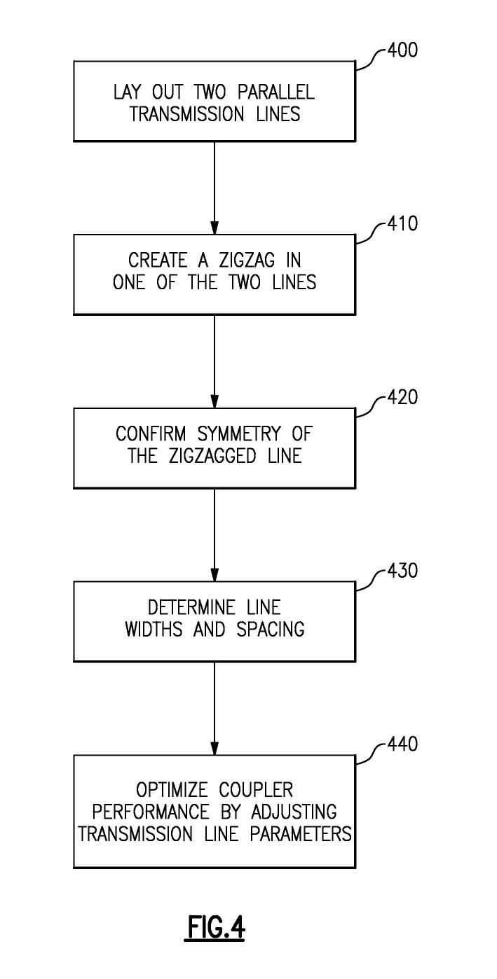

A plan view of one example of a self-compensated coupler according to one embodiment is illustrated in FIG. 3A. A cross-sectional view of the coupler of FIG. 3A is illustrated in FIG. 3B. The coupler 300 comprises a main arm 310 formed in one metal layer of a multi-layer PCB 340, and a coupled arm 320 formed a second metal layer of the multi-layer PCB. In the example illustrated in FIG. 3B, the coupled arm 320 is illustrated below the main arm 310, the two metal layers being separated from one another by a dielectric layer 350; however, it is to be appreciated that the coupled arm may be above or below the main arm. In the illustrated example, the coupled arm 320 includes a “zigzag” 330 positioned mid-way along the coupled arm, dividing the coupled arm into two symmetrical sections. Thus, the coupled line 320 comprises a first section 32aa having a length L1, the zigzag 330, and a second section 320b having a length L2. In one example the lengths L1 and L2 are substantially equal; however in other examples this need not be the case, as discussed further below. It is to be appreciated that the zigzag 330 can alternatively be implemented in the main arm 310. In one embodiment, the zigzag 330 is designed such that each half of the coupled arm 320 is offset (in the y-direction) by an equal amount, but in opposite directions, from the center of the main arm 310. As a result, the coupler is self-compensated for layer misalignment in the y direction because any y-axis misalignment that moves one half of the coupled arm 320 closer to the center of the main arm 310 also moves the other half of the coupled arm further away from the center of the main arm. Therefore, coupling may be equally increased in one half of the coupled arm 320 and decreased in the other half of the coupled arm, resulting in a substantially zero net change in the coupling.

According to one embodiment, the coupler 300 comprises three coupling zones, namely a first zone 380a, roughly corresponding to the length L1 of the first section 320a of the coupled arm, the zigzag 330, and a second zone 380b, roughly corresponding to the length L2 of the second section 320b of the coupled arm. The zigzag 330 corresponds to a reduced couple zone because the transmission line is approximately perpendicular, or close to perpendicular, to the main arm 310. The amount of coupling in the reduced couple zone may be altered by the shape and/or configuration of the zigzag 330. For example, referring to FIG. 3C there is illustrated another example of a self-compensated coupler 300a in which the zigzag is formed using a transmission line section 360 that is approximately perpendicular, in the plane of the metal layer in which it is formed, with respect to the main arm 310. In this example, the reduced couple zone corresponds approximately to the width 370 of the perpendicular transmission line section 360. Another example of a self-compensated coupler is illustrated in FIG. 3D in which the coupled arm 320 has a “Z” shape. In this example, the zigzag 330 is configured such it overlaps in the x-direction with the first and second sections of the coupled line 320. As a result, the reduced couple zone may be reduced or eliminated. In addition, changing the shape of the zigzag may impact the capacitance of the transmission line more than the inductance; therefore, the shape of the zigzag may also be selected based on desired LC (inductance/capacitance) properties of the coupler. It is to be appreciated that embodiments of the self-compensated coupler may use any of the various zigzag configurations illustrated in FIGS. 3A, 3C and 3D, or variations thereof. It is further to be appreciated that any of the above described configurations may be implemented in the main arm 310 rather than the coupled arm 320.

As discussed above, in one embodiment, the two sections 320a, 320b of the coupled arm 320 on either side of the zigzag 330 have substantially equal lengths (L1≈L2) and the coupled arm is symmetrical about the zigzag. However, in other embodiments, L1 may differ from L2, for example, depending on various coupler and/or system constraints or desired characteristics, such as coupling factor, directivity, circuit layout constraints, etc., and/or to control the degree of coupling occurring in the first coupling zone 380a relative to the second coupling zone 380b. In addition, in another embodiment, one or both of the first and second sections 320a, 320b of the coupled arm 320 may be tapered, as shown for example in FIG. 3E. As discussed further below, coupling between the main arm 310 and the coupled arm 320 is affected by the width of the transmission lines. Thus, by varying the width of at least one arm using a taper, the coupling can be altered along the length of the coupler. Additionally, the taper may be used to alter the capacitance and/or inductance along the length of the coupler, for example, to create a harmonic filter. It is to be appreciated that the taper may be uniform (as shown in FIG. 3E), segmented (e.g., the arm may comprise one or more tapered sections interspersed with one or more parallel/“straight” sections), or non-uniform. Furthermore, although the coupled arm 320 is illustrated with the taper in FIG. 3E, it is to be appreciated that the taper may alternatively be implemented in the main arm 310. In addition, a tapered coupled arm 320 (or main arm 310) may be implemented with any of the zigzag 330 configurations discussed above.

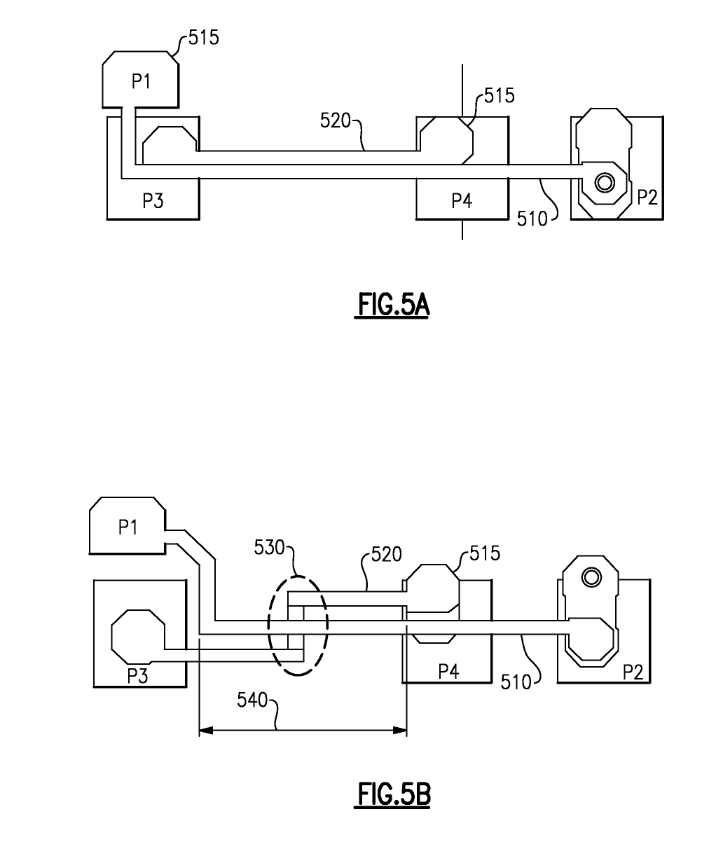

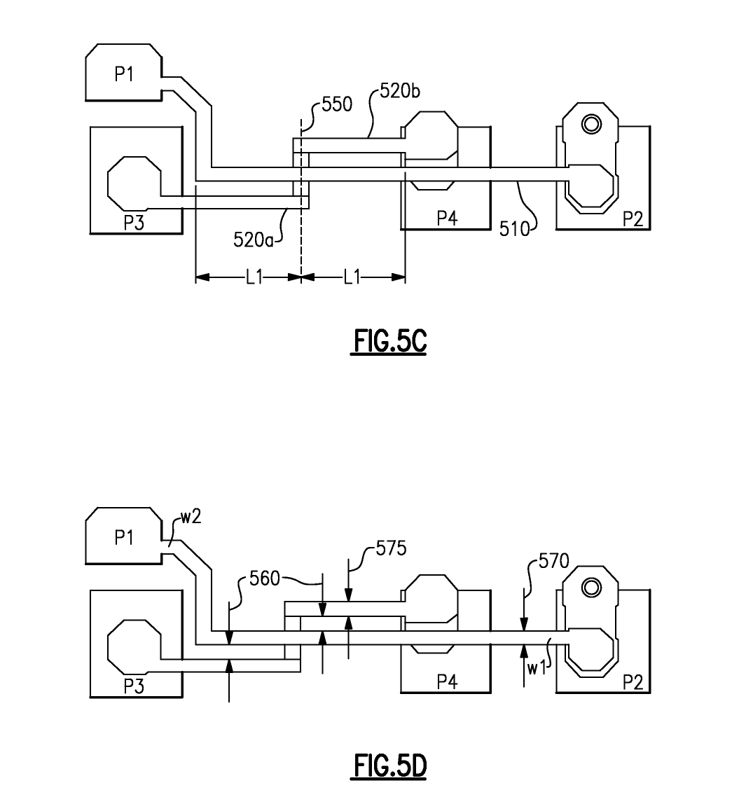

A method for designing a self-compensated coupled line coupler according to one embodiment is now described with reference to FIG. 4. In step 400, two microstrip lines are laid out overlaying and parallel to each other in the Z-direction on PCB/laminate package, as shown in FIG. 5A. For simplicity, the following discussion assumes that the main RF arm 510 is formed in the upper layer of the PCB and that the coupled arm is formed in the lower layer of the PCB; however, it is to be appreciated that the opposite arrangement may be implemented. In addition, the overall PCB package may include one or more layers above and/or below the layers in which the coupler 300 is implemented. The transmission lines for the main arm 510 and coupled arm 520 terminate in pads 515 for connection to the ports P1, P2, P3 and P4.

In step 410, a “kink” or “zigzag” 530 is created in either the main arm transmission line 510 or the coupled arm transmission line 520 to compensate for manufacturing process variations. In the example illustrated in FIG. 5B, the zigzag 530 is created in the coupled arm 520; however, as discussed above, the zigzag may alternatively be formed in the main arm 510. It is also to be appreciated that although the illustrations in FIGS. 5B-5E show a zigzag with a perpendicular transmission line segment, the coupler may instead be implemented using any of the zigzag configurations discussed above. In one embodiment, the zigzagged line is symmetric about a center 550 of the zigzag 530 over the extent of the coupling region 540, as shown in FIG. 5C, such that the two segments 520a, 520b of the zigzagged line are equal in length (L1), within manufacturing tolerances. Symmetry of the zigzagged line allows both line segments 520a, 520b to equally adjust the coupling factor to compensate for misalignment between the coupled arm 520 and the main arm 510. Therefore, the method may include a step 420 of ensuring that the two line segments 520a, 520b have substantially the same length L1. As discussed above, however, in other examples the lengths of the two line segments 520a, 520b may differ, in which case step 420 may be replaced with a step in which the lengths of the line segments are verified according to a desired configuration.

The coupling factor, C, depends on the width of the transmission lines forming the main arm 510 and coupled arm 520 and the spacing 560 between the lines (illustrated in FIG. 5D). Accordingly, embodiments of the method for designing a self-compensated coupler 300 may include a step 430 of determining and selecting line widths 570, 575 of the main arm 510 and coupled arm 520 lines, respectively, as well as the spacing 560 between the lines. For example, reducing the spacing between the main arm 510 and the coupled arm 520, as shown in FIG. 5E, will increase the coupling strength. The coupling factor may also be increased by increasing the line width(s) 570 and/or 575.

According to one embodiment, the method may further include a step 440 of optimizing or tuning the coupler performance by evaluating and adjusting, if necessary, coupler parameters such as line width, line lengths, and layout. Generally, there may be a tradeoff between an optimized layout (i.e., one that consumes little PCB space), coupling factor, isolation and directivity. For example, although increasing the line widths 570, 575 increases the coupling factor, if the lines are made too wide, the coupler isolation may be negatively impacted. Furthermore, the line widths 570, 575 should be sufficiently large such that manufacturing tolerances in the line formation process, for example, an etching process, do not significantly impact the coupler performance. In one example, for a coupler having a 20 dB coupling factor and designed for a center operating frequency of approximately 836 MHz, the line widths 570, 575 can be approximately 80 micrometers (μm) and 55 μm, respectively. In another example, for a similar coupler having a 20 dB coupling factor and designed for a center operating frequency of approximately 1800 MHz, the line widths 570, 575 can be approximately 60 μm and 55 μm, respectively. The spacing 560 and line lengths L1 can also be adjusted to achieve a desired coupling factor and isolation and to optimize the overall coupler performance.

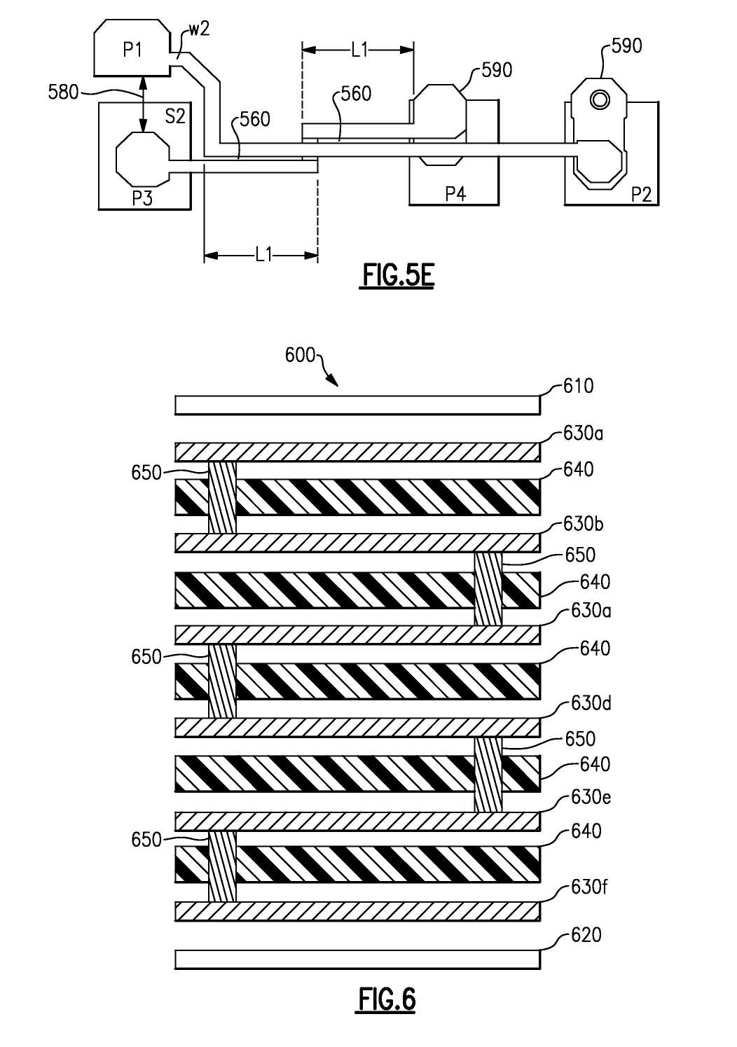

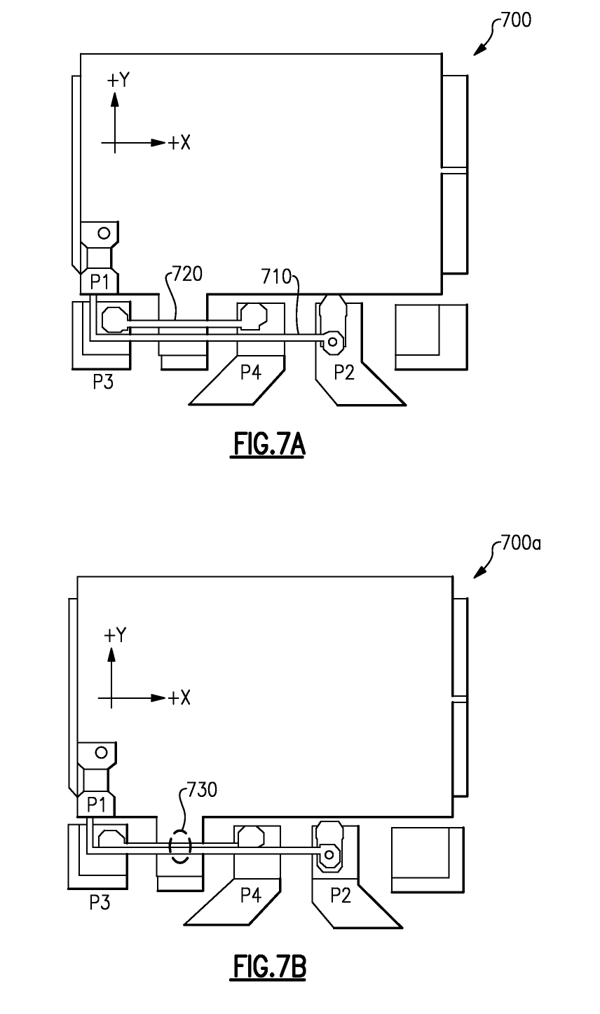

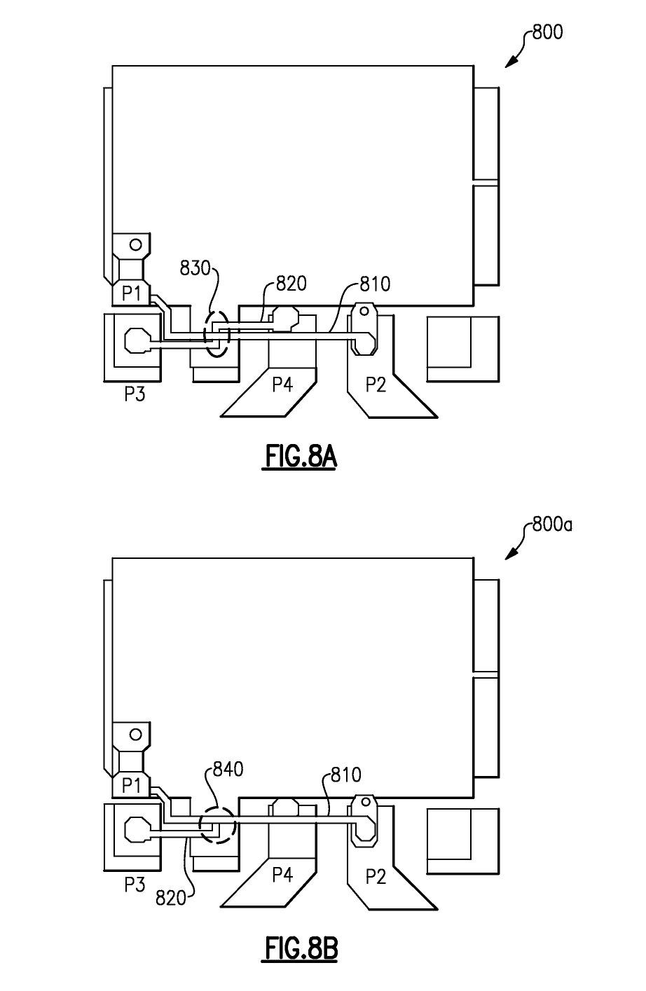

Referring to FIG. 5E, the spacing 580 between the connection terminals for the input port P1 and coupled port P3 can also be adjusted to optimize the coupler performance. For example, increasing the spacing 580 may improve the isolation and/or directivity of the coupler. In one embodiment, metal via caps 590 can be included on the transmitted and isolated ports P2 and P4, respectively, to improve isolation between the transmitted port P2 and the coupled port P3, given by S-parameter S(3,2). However, these caps 590 may significantly impact the return loss at the coupled port, S(3,3), and isolated port, S(4,4). Accordingly, there is a tradeoff between improved isolation and worsened return loss to be considered when including the metal caps 590. For example, larger caps 590 may negatively affect the return loss, but improve directivity. Accordingly, where there is some margin in the return loss performance of the coupler relative to a specification that the coupler is designed to meet, return loss can be “traded-off” to allow larger caps 590 which improve directivity. In one example, in which the coupler is implemented in a laminate package, the caps 590 are approximately the same size as standard vias used to connect various metal layers in the laminate package (shown in FIG. 6). For specific implementations, the size of the metal caps 590 can be determined or optimized by simulating performance of the coupler with various sized caps, for example, beginning with a cap having the same size as standard vias used in the package, and varying the size while monitoring the simulated directivity and return loss of the coupler.

In addition, the distance from the coupler to the ground plane affects the isolation performance of the coupler, and therefore may be considered when laying out the coupler in the multi-layer printed circuit board. For example, for a four-Layer MCM (multi-chip module) PCB, the “Metal1” layer may be used for the main arm of the coupler and the “Metal2” layer may be used for the coupled arm. In another example, for a six-layer MCM PCB, the Metal2 layer may be used for the main arm and the Metal3 layer for the coupled arm because the distance to the ground plane of a six-layer MCM is greater than in a four-layer MCM. Referring to FIG. 6 there is illustrated a schematic diagram of one example of a six-layer MCM 600. The MCM 600 includes a top soldermask 610 and bottom soldermask 620, and six metal layers 630a (Metal1), 630b (Metal2), 630c (Metal3), 630d (Metal4), 630e (Metal5), and 630f (Metal6) which is the ground plane. The metal layers 630a-f are separated from one another by dielectric layers 640. The metal layers 630a-f are interconnected by vias 650. The coupler may be implemented in any two metal layers 630a-f.

Embodiments of the above-discussed coupler structure and method of designing the coupler provide several advantages over conventional strip-coupled couples, including reduced cost, reduced time to market for electronic modules incorporating the coupler, and improved performance and robustness with respect to manufacturing process variations. Unlike prior solutions discussed above, embodiments of the self-compensated coupler do not require extra components to be added to the coupler. This has the advantage of reduced package size and also saving on surface mount component cost relative to conventional compensated coupler designs. In addition, embodiments of the coupler save engineers tuning time, avoid the need for “trial and error” approaches to coupler design, and reduce module iterations in manufacturing because the coupler compensates its own performance.

As discussed above, examples of a conventional strip coupled coupler and a self-compensated coupler have been simulated to illustrate the relative performance and characteristics of an embodiment of the self-compensated coupler. In particular, some examples of −20 dB coupled-line structures for WCMDA applications having a low operating frequency band centered at approximately 836 MHz (referred to as the “lowband”) and a high operating frequency band centered at approximately 1800 MHz (referred to as the “highband”) were designed, simulated and fabricated. A three-dimensional Electromagnetic (EM) HFSS simulation program was used to optimize the coupler designs and validate the performance changes with alignment variations, as discussed further below. Those skilled in the art will appreciate that the same techniques discussed above can be used to design and validate a coupler for any RF application (and/or frequency range) including but not limited to GSM, WCDMA, LTE and Wimax, where a controlled coupling feedback is desired, for example, from the output of a power amplifier.

Referring to FIG. 7A, there is illustrated a diagram of a nominal or “ideal” circuit board layout of a simulated conventional strip coupled coupler 700 including a main line 710 and a coupled line 720. FIG. 7B illustrates the circuit board layout for the conventional coupler 700a with a misalignment 730 in the y-direction. Simulations of the coupling factor, isolation and directivity for both the nominal conventional coupler and the misaligned conventional coupler were run over various frequency ranges using a three-dimensional electromagnetic HFSS simulation program available from Ansoft Corporation. For the simulations, a misalignment of + and −60 micrometers (μm) in the y-direction was used. The results of the simulations are discussed below.

FIG. 8A illustrates an example of a circuit board layout for a nominal self-compensated coupler 800 including a main line 810, a coupled line 820, and a zigzag 830 formed in the coupled line, as discussed above. FIG. 8A illustrates the circuit board layout for the self-compensated coupler 800a with a misalignment 840 in the y-direction. Simulations of the coupling factor, isolation and directivity of the self-compensated coupler were run using the same simulation program, conditions and frequency ranges as for the conventional coupler examples, with a specified misalignment 840 of +60 μm and −60 μm. The results of the simulations are discussed below.

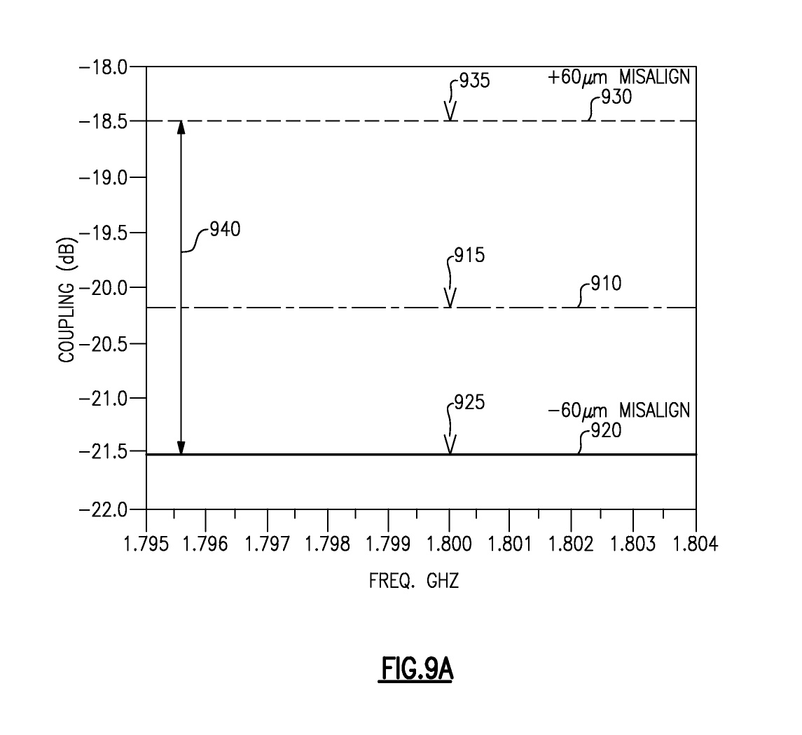

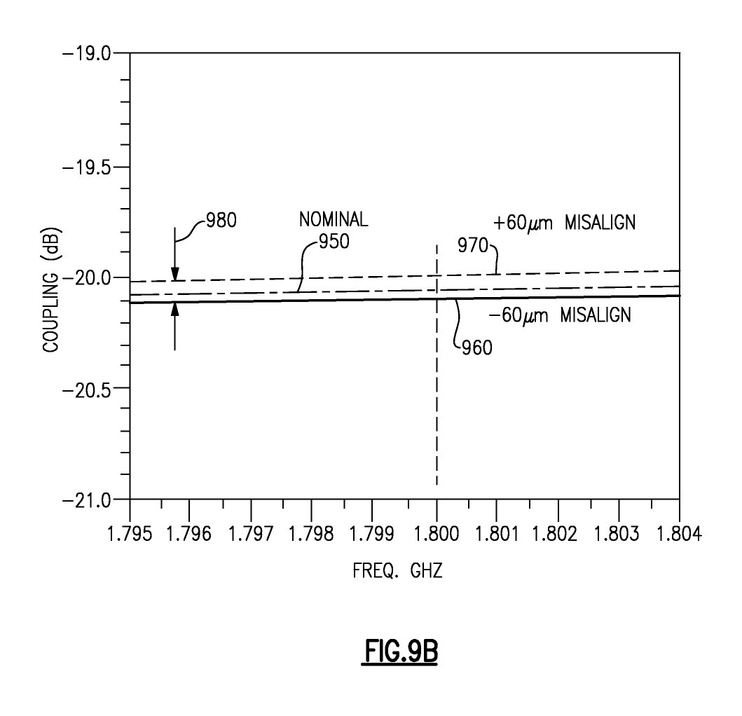

FIG. 9A illustrates a graph of the coupling factor in dB (C) of the conventional couplers 700, 700a as a function of frequency (in gigahertz (GHz)) over the simulated frequency range of 1.795 GHz to 1.804 GHz. The coupling factor can be defined as

$$C = - 10 log ( \frac{{P}_{3}}{{P}_{2}} ) dB \qquad ( 1 )$$

In Equation (1), P₂ is the power at the transmitted port and P₃ is the output power from the coupled port (see FIG. 1). The coupling factor (in dB) can also be expressed in terms of the S parameters of the coupler as:

$$C = ( \frac{S ( 3 , 1 )}{S ( 2 , 1 )} ) dB \qquad ( 2 )$$

In Equation 2, S(3,1) is the transmission parameter from the input port to the coupled port and S(2,1) is the transmission parameter from the input port to the transmitted port. Thus, the coupling factor represents the ratio of the signal at the coupled port to the signal at the transmitted port, for a signal applied at the input port. In FIG. 9A, trace 910 represents the coupling factor of the nominal conventional coupler 700, trace 920 represents the coupling factor of the conventional coupler 700a with a misalignment in the y-direction of −60 μm, and trace 930 represents the coupling factor of the conventional coupler 700a with a misalignment in the y-direction of +60 μm. Specifically, the nominal conventional coupler 700 has a coupling factor of approximately −20.156 dB at 1,800 GHz (represented by marker 915), whereas the misaligned coupler 700a has a coupling factor of approximately −21.515 dB at 1,800 GHz with a misalignment of −60 μm (represented by marker 925) and a coupling factor of approximately −18.473 dB at 1,800 GHz with a misalignment of +60 μm (represented by marker 935). Thus, as can be seen with reference to FIG. 9A, the misalignment 730 causes a wide variation 940 in the coupling factor over the simulated frequency range.

FIG. 9B illustrates a graph of the coupling factor in dB (C) of the example self-compensated couplers 800, 800a as a function of frequency (in gigahertz (GHz)) over the same simulated frequency range of 1.795 GHz to 1.804 GHz. In FIG. 9B, trace 950 represents the coupling factor of the nominal self-compensated coupler 800, trace 960 represents the coupling factor of the self-compensated coupler 800a with a misalignment in the y-direction of −60 μm, and trace 970 represents the coupling factor of the self-compensated coupler 800a with a misalignment in the y-direction of +60 μm. Specifically, the nominal self-compensated coupler 800 has a coupling factor of approximately −20.065 dB at 1,800 GHz, and the misaligned coupler 800a has a coupling factor at 1,800 GHz of approximately −20.098 dB at 1,800 GHz with a misalignment of −60 μm and approximately −19.997 dB with a misalignment of +60 μm. Thus, as can be seen with reference to FIG. 9B, even with the misalignment 840, there is little variation 980, less than 1 dB at 1,800 GHz, in the coupling factor of the self-compensated coupler over the simulated frequency range.

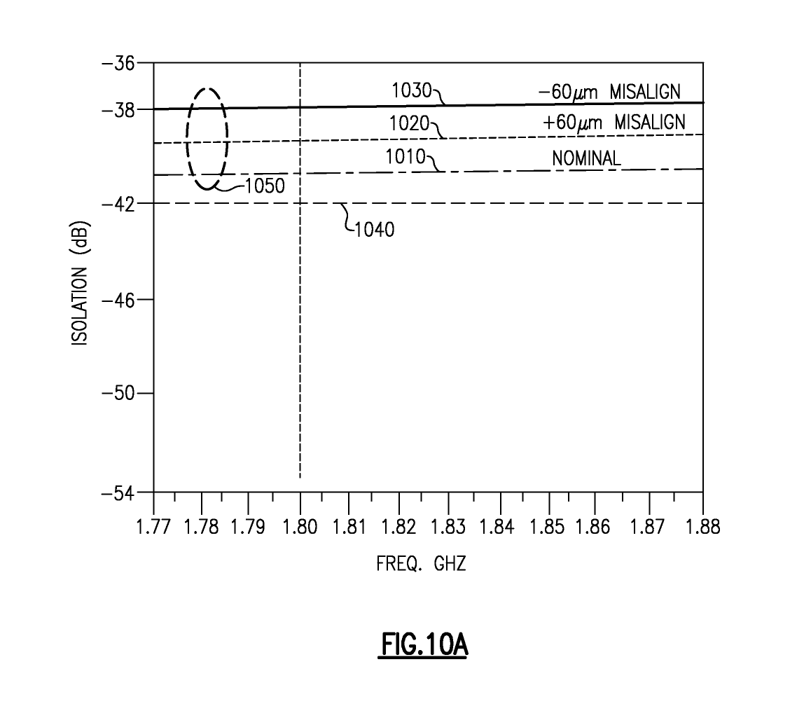

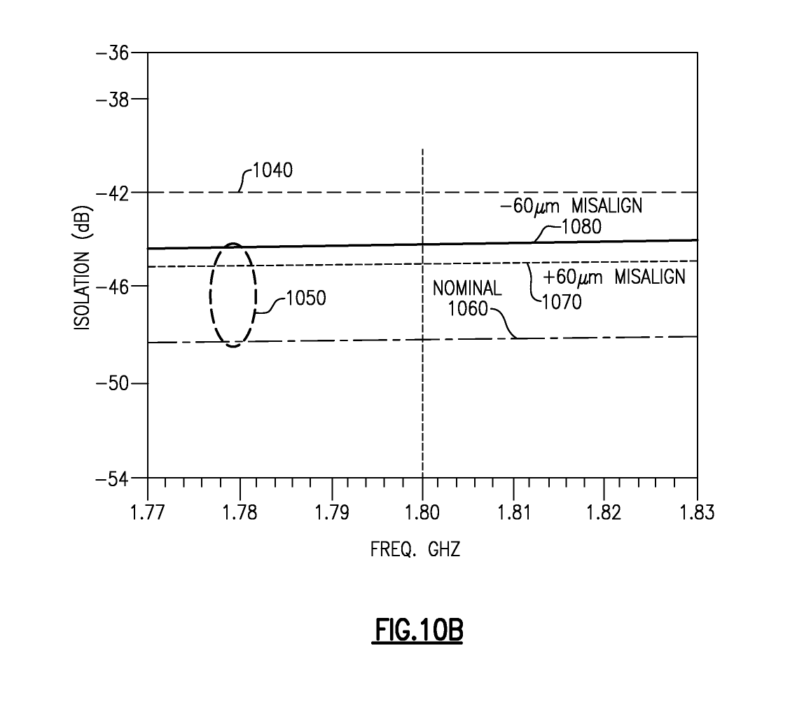

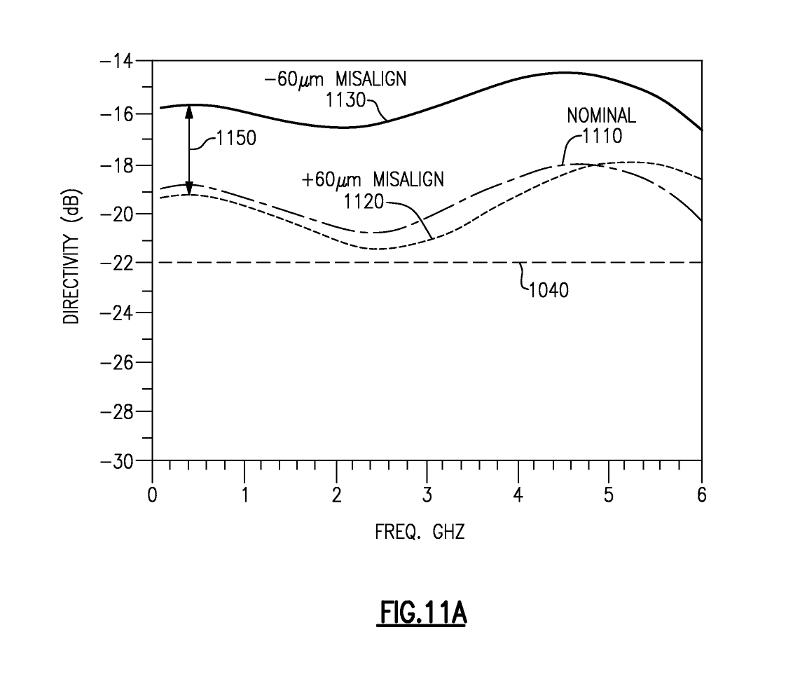

Referring to FIG. 10A there is illustrated a graph of the isolation in dB of the example simulated conventional couplers 700, 700a over a simulated frequency range of 1.77 GHz to 1.88 GHz. In FIG. 10A, trace 1010 represents the isolation of the nominal conventional coupler 700, trace 1020 represents the isolation of the conventional coupler 700a with a misalignment in the y-direction of +60 μm, and trace 1030 represents the isolation of the conventional coupler 700a with a misalignment in the y-direction of −60 μm. It can be seen that for each of the three simulated couplers 700, 700a, the isolation did not meet the specified target isolation 1040 of −42 dB over the simulated frequency range. The variation 1050 in the isolation of the three different simulations is approximately 2.5 dB. Specifically, at 1,800 GHz, the isolation of the nominal conventional coupler 700 is approximately −40.627 dB. The isolation at 1,800 GHz of the misaligned conventional coupler 700a is approximately −39.309 dB with a misalignment of +60 μm and approximately −38.004 dB with a misalignment of −60 μm.

FIG. 10B illustrates a graph of the isolation in dB of the example simulated self-compensated couplers 800, 800a over the same simulated frequency range of 1.77 GHz to 1.88 GHz. In FIG. 10B, trace 1060 represents the isolation of the nominal self-compensated coupler 800, trace 1070 represents the isolation of the self-compensated coupler 800a with a misalignment in the y-direction of +60 μm, and trace 1080 represents the isolation of the self-compensated coupler 800a with a misalignment in the y-direction of −60 μm. The variation 1050 in isolation is slightly increased relative to the conventional couplers 700, 700a, being approximately 4 dB. However, it can be seen that for each of the three simulated self-compensated couplers 800, 800a, the isolation meets the specified target isolation 1040 of −42 dB over the simulated frequency range. Specifically, at 1,800 GHz, the isolation of the nominal self-compensated coupler 700 is approximately −48.175 dB. The isolation at 1,800 GHz of the misaligned self-compensated coupler 800a is approximately −44.929 dB with a misalignment of +60 μm and approximately −44.103 dB with a misalignment of −60 μm.

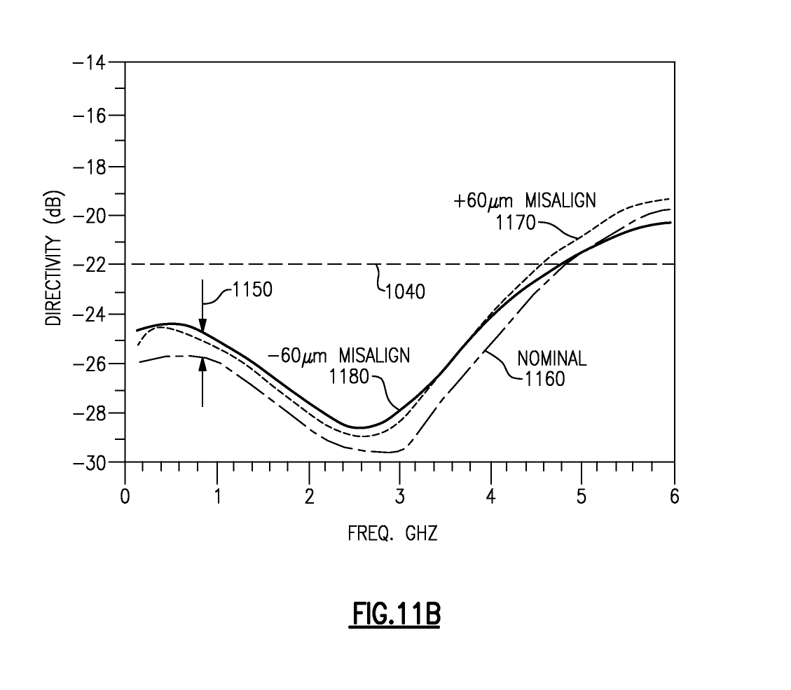

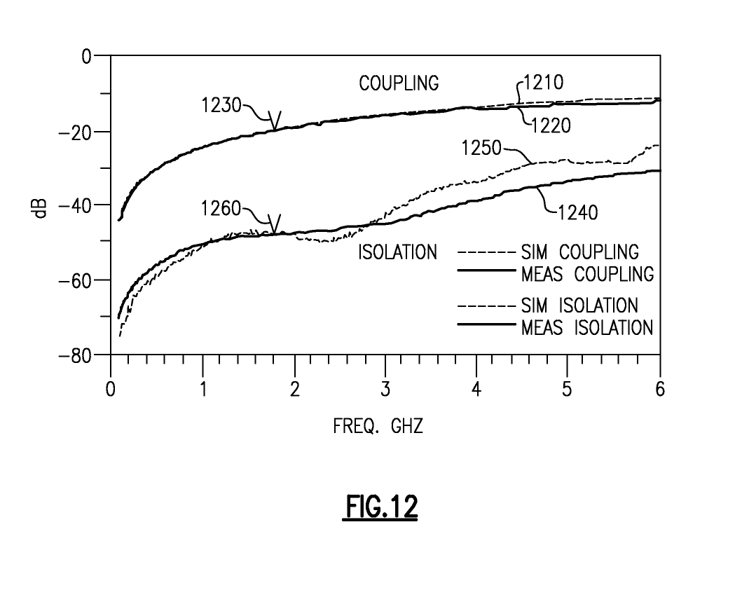

Referring to FIG. 11A there is illustrated a graph of the directivity in dB of the example simulated conventional couplers 700, 700a over a simulated frequency range of 0-6 GHz. In FIG. 11A, trace 1110 represents the directivity of the nominal conventional coupler 600, trace 1120 represents the directivity of the conventional coupler 700a with a misalignment in the y-direction of +60 μm, and trace 1130 represents the directivity of the conventional coupler 700a with a misalignment in the y-direction of −60 μm. It can be seen that for each of the three simulated couplers 700, 700a, the directivity did not meet the specified target directivity 1140 of −22 dB (based on a desired coupling factor of −20 dB and a base-line isolation of 42 dB) over the simulated frequency range. In addition, there is a large variation 1150 in the directivity of the three different simulated example couplers. Specifically, at 1,800 GHz, the directivity of the nominal conventional coupler 700 is approximately −20.471 dB. The directivity at 1,800 GHz of the misaligned conventional coupler 700a is approximately −20.836 dB with a misalignment of +60 μm and approximately −16.488 dB with a misalignment of −60 μm.

FIG. 11B illustrates a graph of the directivity in dB of the example simulated self-compensated couplers 800, 800a over the same simulated frequency range of 0-6 GHz. In FIG. 11B, trace 1160 represents the simulated directivity of the nominal self-compensated coupler 800, trace 1170 represents the simulated directivity of the self-compensated coupler 800a with a misalignment in the y-direction of +60 μm, and trace 1180 represents the simulated directivity of the self-compensated coupler 800a with a misalignment in the y-direction of −60 μm. As can be seen with reference to FIG. 11B, each of the three simulated couplers 800, 800a have a directivity that meets the specified target 1140 over the majority of the simulated frequency range from 0 GHz to about 4.5 GHz. Specifically, at 1,800 GHz, the directivity of the nominal self-compensated coupler 800 is approximately −28.110 dB. The directivity at 1,800 GHz of the misaligned self-compensated coupler 800a is approximately −27.406 dB for a misalignment of +60 μm and approximately −27.168 dB for a misalignment of −60 μm In addition, the variation 1150 in directivity between the two misaligned examples and the nominal example is greatly reduced compared to the variation 1150 in directivity for the simulated conventional couplers shown in FIG. 11A.

The above-discussed simulation results demonstrate that examples of a self-compensated coupler according to embodiments of the present invention can provide a stable coupling factor even in circumstances of significant misalignment between the different layers of a printed circuit board in which the coupler is fabricated. In addition, the simulations demonstrate that examples of the self-compensated coupler also have good directivity and isolation, meeting the relevant industry standard specifications.

An example of the self-compensated coupler 800 was manufactured and its isolation and coupling factor measured and compared with a simulation of the same coupler. Referring to FIG. 12 there is illustrated a graph of simulated and measured isolation and coupling factor for the example self-compensated coupler 800 over a frequency range of 0-6 GHz. In FIG. 12, trace 1210 represents the simulated coupling factor of the self-compensated coupler 800, and trace 1220 represents the measured coupling factor of the self-compensated coupler. As can be seen with reference to FIG. 12, there is very good agreement between the measured and simulated coupling factor over the whole frequency range. At 1,800 GHz, the measured and simulated coupling factor, represented by marker 1230, is approximately −20.065 dB. Trace 1240 represents the simulated isolation of the self-compensated coupler 800, and trace 1250 represents the measured isolation of the self-compensated coupler. Again, there is good agreement between the measured and simulated coupling factor over the frequency range. At 1,800 GHz, the measured and simulated isolation, represented by marker 1260, is approximately −48.175 dB.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A directional coupler comprising:
a main arm formed in a single first layer of a multi-layer substrate; and
a coupled arm formed in a single second layer of the multi-layer substrate, one of the coupled arm and the main arm including a zigzag structure having a first portion and a second portion connected by a joining portion.

2. The directional coupler as claimed in claim 1, wherein the first layer is a first metal layer of the multi-layer substrate, the second layer is a second metal layer of the multi-layer substrate, and the first and second metal layers are separated from one another by a dielectric layer, the second metal layer being closer to a ground plane of the multi-layer substrate than the first metal layer.

3. The directional coupler as claimed in claim 1, further comprising an input port coupled to a proximal end of the main arm, a transmitted port coupled to a distal end of the main arm, a coupled port coupled to a proximal end of the coupled arm, and an isolated port coupled to a distal end of the coupled arm.

4. The directional coupler as claimed in claim 1, wherein the multi-layer substrate is a multi-layer printed circuit board.

5. The directional coupler as claimed in claim 1, wherein the main arm includes the zigzag structure.

6. The directional coupler as claimed in claim 1, wherein the coupled arm includes the zigzag structure.

7. The directional coupler as claimed in claim 6, wherein the joining portion is substantially perpendicular to the first and second portions in a plane of the second layer.

8. The directional coupler as claimed in claim 6, wherein the zigzag structure is approximately centered about the main arm.

9. The directional coupler as claimed in claim 6, wherein a width of the coupled arm is tapered on either side of the zigzag such that the width of the coupled arm increases with distance away from the zigzag.

10. The directional coupler as claimed in claim 6, wherein the zigzag structure has a “Z” shape.

11. A method of designing a self-compensated directional coupler, the method comprising:
laying out two parallel transmission lines, the two parallel transmission lines including a main line and a coupled line;
creating a zigzag in one of the main line and the coupled line, the zigzag being approximately symmetrical about the other of the main line and the coupled line; and
determining a first width of the main line, a second width of the coupled line, and a spacing between the main line and the coupled line based on predetermined desired performance characteristics of the self-compensated directional coupler.

12. The method as claimed in claim 11, further comprising optimizing at least one of the performance characteristics of the self-compensated directional coupler by adjusting parameters of the two transmission lines.

13. The method as claimed in claim 12, wherein adjusting the parameters of the two transmission lines includes adjusting at least one of the first width, the second width, and the spacing.

14. The method as claimed in claim 11, wherein determining the first width, the second width and the spacing includes determining the first width, the second width and the spacing based at least in part on a desired coupling factor of the self-compensated directional coupler.

15. The method as claimed in claim 11, wherein creating the zigzag includes creating the zigzag in the coupled line, the zigzag being approximately symmetrical about the main line.

16. The method as claimed in claim 11, wherein creating the zigzag includes creating the zigzag in the main line, the zigzag being approximately symmetrical about the coupled line.
